(19) United States
(12) Patent Application Publication
(10) Pub. No.: US 2012/0281233 A1
(43) Pub. Date: Nov. 8, 2012

(54) MEASUREMENT APPARATUS

(75) Inventor: Hiroyuki Yuki, Utsunomiya-shi (JP)

(73) Assignee: CANON KABUSHIKI KAISHA, Tokyo (JP)

(21) Appl. No.: 13/459,962

(22) Filed: Apr. 30, 2012

(30) Foreign Application Priority Data
May 6, 2011 (JP) 2011-103788

(51) Int. Cl. G01B 11/24

(52) U.S. Cl. 356/477; 356/511

(57) ABSTRACT

The present invention provides a measurement apparatus which measures a height of a surface to be measured, including a detection unit configured by two-dimensionally arraying a plurality of regions where an intensity of interference light between reference light and measurement light is detected, a first optical system configured to split light emitted by a light source into first light and second light, a generation unit configured to receive the first light, and generate, from the first light, the reference light including a plurality of reference beams having optical path length differences in two directions perpendicular to each other in cross section surface, and a second optical system configured to cause the reference light to reach the detection unit so as to cause the respective reference beams generated by the generation unit to reach the corresponding regions.

### BACKGROUND OF THE INVENTION

1. Field of the Invention

The present invention relates to a measurement apparatus which measures the height of a surface to be measured.

2. Description of the Related Art

White light interferometry using a low-coherent light source is known as a technique for measuring the height of a surface (upper or lower surface) to be measured in a measurement object or the height of a layer inside a measurement object (see Japanese Patent Laid-Open Nos. 2006-64610 and 2007-333470 and “OPTICS EXPRESS/Vol. 14, No. 12, 5201/12 Jun. 2006” (literature 1)). The white light interferometry causes light (measurement light) reflected by a surface to be measured to interfere with reference light, and obtains the height of the surface to be measured from the intensity (light interference signal) of the interference light.

For example, Japanese Patent Laid-Open No. 2006-64610 and literature 1 disclose techniques for measuring a layer inside a measurement object. Japanese Patent Laid-Open No. 2007-333470 discloses a technique for measuring the shape (surface shape) of a surface to be measured in a measurement object.

However, the conventional techniques cannot achieve both high measurement accuracy and a wide measurement range in measurement of the height of a surface to be measured. To measure the height of a surface to be measured at high accuracy, it is necessary to finely set, in the wavelength order, the optical path length difference between reference beams incident on respective pixels (detection regions) which form a detection unit for detecting interference light. The measurement range in the direction of height of a surface to be measured is limited to a value obtained by multiplying the optical path length difference set between reference beams by the total number of pixels which form the detection unit. However, in the current techniques, the number of pixels which can be arrayed in one direction is about several thousand to several ten thousand at most. When a line sensor is used as the detection unit as in literature 1, if priority is given to high measurement accuracy, the measurement range narrows, and if priority is given to a wide measurement range, the measurement accuracy decreases.

Japanese Patent Laid-Open No. 2006-64610 discloses the use of a two-dimensional sensor as the detection unit. However, in Japanese Patent Laid-Open No. 2006-64610, pixels arrayed in one direction out of two-dimensionally arrayed pixels are used to measure the height (for example, in the Z direction) of a surface to be measured. Pixels arrayed in the other direction are used to measure the position (for example, in the X and Y directions perpendicular to the Z direction) of the surface to be measured. In Japanese Patent Laid-Open No. 2006-64610, the two-dimensional sensor is used substantially as a line sensor in measurement of the height of a surface to be measured. Thus, this technique cannot achieve both high measurement accuracy and a wide measurement range.

Japanese Patent Laid-Open No. 2007-333470 discloses a technique in which a plurality of reference surfaces are arranged two-dimensionally and a two-dimensional sensor is used. However, in Japanese Patent Laid-Open No. 2007-333470, an optical system converges light for irradiating reference surfaces. The number of reference surfaces irradiated with light is limited to be small, and the optical path length difference cannot be set small between reference beams. The optical path length difference between reference beams incident on respective pixels which form the two-dimensional sensor differs only between three pixel columns, and does not differ between pixels (on respective rows) within a column. Even the technique in Japanese Patent Laid-Open No. 2007-333470 hardly achieves both high measurement accuracy and a wide measurement range.

To widen the measurement range, the conventional techniques need to drive the reference surface (that is, require the driving time), and take time for measurement.

### SUMMARY OF THE INVENTION

The present invention provides a technique advantageous in achieving both high measurement accuracy and a wide measurement range in measurement of the height of a surface to be measured.

According to one aspect of the present invention, there is provided a measurement apparatus which measures a height of a surface to be measured, including a detection unit configured by two-dimensionally arraying a plurality of regions where an intensity of interference light between reference light and measurement light is detected, a first optical system configured to split light emitted by a light source into first light and second light, a generation unit configured to receive the first light, and generate, from the first light, the reference light including a plurality of reference beams having optical path length differences in two directions perpendicular to each other in cross section surface, a second optical system configured to cause the reference light to reach the detection unit so as to cause the respective reference beams generated by the generation unit to reach the corresponding regions, a third optical system configured to focus the second light on a measurement point of the surface to be measured, a fourth optical system configured to cause the second light to reach the detection unit as the measurement light so as to cause the second light reflected by the measurement point to reach the respective regions, and a processing unit configured to calculate the height of the surface to be measured at the measurement point from the intensity of the interference light detected in the respective regions.

Further aspects of the present invention will become apparent from the following description of exemplary embodiments with reference to the attached drawings.

### BRIEF DESCRIPTION OF THE DRAWINGS

FIGS. 1A and 1B are schematic views showing the arrangement of a measurement apparatus according to an embodiment of the present invention.

FIGS. 2A and 2B are views exemplifying the arrangement of the detection unit of the measurement apparatus shown in FIGS. 1A and 1B and the intensity of interference light detected by the detection unit.

FIGS. 3A and 3B are views schematically exemplifying the arrangement of the reference light generation unit of the measurement apparatus shown in FIGS. 1A and 1B.

FIGS. 4A and 4B are views schematically exemplifying the arrangement of an optical path length difference generation unit.

FIGS. 5A and 5B are views schematically exemplifying another arrangement of the reference light generation unit of the measurement apparatus shown in FIGS. 1A and 1B.

FIG. 6 is a view schematically showing the arrangement of a first optical path length difference generation unit.

FIGS. 7A and 7B are views schematically exemplifying the arrangement of a first diffractive optical element.

FIG. 8 is a view schematically showing the arrangement of a second optical path length difference generation unit.

FIG. 9 is a view schematically showing another arrangement of the first optical path length difference generation unit.

FIG. 10 is a view schematically showing another arrangement of the second optical path length difference generation unit.

FIG. 11 is a view schematically exemplifying another arrangement of the optical path length difference generation unit.

FIGS. 12A to 12C are views schematically exemplifying the arrangement of a diffractive optical element.

FIG. 13 is a view schematically showing another arrangement of the optical path length difference generation unit.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

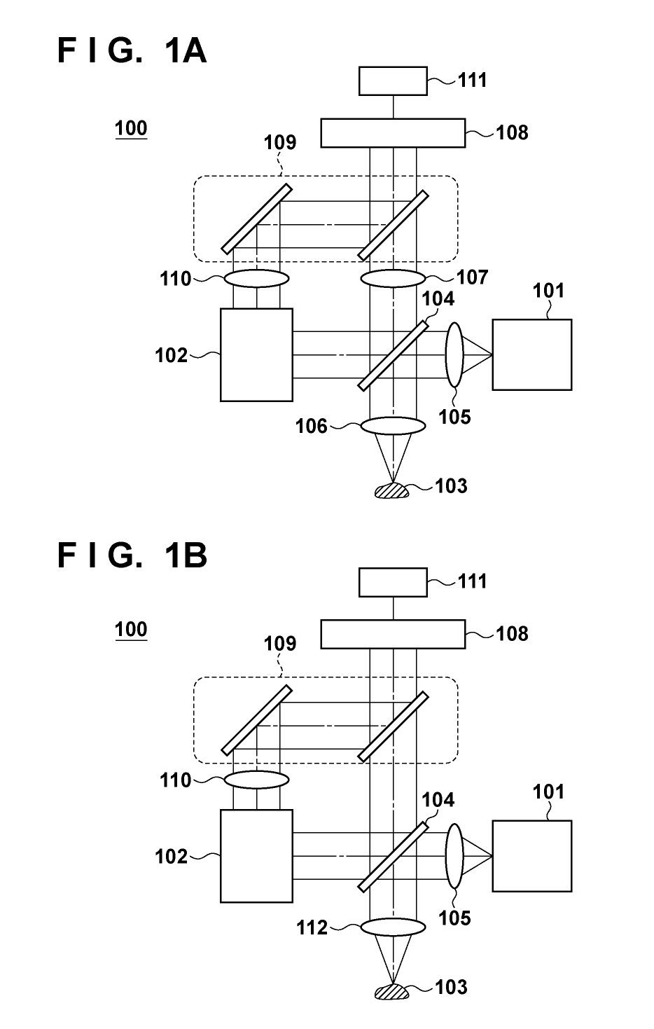

FIG. 1A is a schematic view showing the arrangement of a measurement apparatus 100 according to an embodiment of the present invention. The measurement apparatus 100 measures the height of a surface 103 to be measured in a measurement object. The surface 103 to be measured includes the outer surface or internal layer surface of a measurement object. The measurement apparatus 100 splits, by a half mirror (first optical system) 104, light emitted by a low-coherent light source 101 into light (first light) which travels toward a reference light generation unit 102, and light (second light) which travels toward the surface 103 to be measured. The measurement apparatus 100 causes the reference light generated by the reference light generation unit 102 and light (measurement light) reflected by the surface 103 to be measured to interfere with each other, and detects the intensity of the interference light by a detection unit 108. A processing unit (computer) 111 acquires data of the intensity (detection signal) of the interference light that has been detected by the detection unit 108, and calculates the height of the surface 103 to be measured using the data.

The arrangement of the measurement apparatus 100 and processing for measuring the height of the surface 103 to be measured will be explained in detail. The measurement apparatus 100 includes an optical system 105 which is inserted in an optical path between the low-coherent light source 101 and the reference light generation unit 102. The optical system 105 causes one beam (first light) out of two beams split by the half mirror 104 to enter the reference light generation unit 102 as parallel light (almost parallel light). The optical system 105 is formed from one lens in FIG. 1A, but may be formed from a plurality of lenses, a plurality of mirrors, or the like. In FIG. 1A, one optical system 105 is inserted in an optical path between the low-coherent light source 101 and the half mirror 104. However, a plurality of optical systems 105 may be inserted in an optical path between the low-coherent light source 101 and the reference light generation unit 102 so that parallel light enters the reference light generation unit 102.

The reference light generation unit 102 includes an optical path length difference generation unit 201. The reference light generation unit 102 generates, from the entered parallel light, reference light including a plurality of reference beams having two-dimensional optical path length differences on a section perpendicular to the direction in which light propagates. In other words, the reference light generation unit 102 generates the reference light including a plurality of reference beams having optical path length differences in two directions perpendicular to each other in cross section surface. The arrangement of the reference light generation unit 102 will be described in detail later.

The detection unit 108 is formed from a two-dimensional CCD sensor or two-dimensional CMOS sensor in which a plurality of regions (detection regions) such as CCD or MOS elements (photoelectric conversion elements) are two-dimensionally arrayed to detect the intensity of interference light between reference light and measurement light. However, the detection unit 108 is not limited to the two-dimensional CCD sensor or two-dimensional CMOS sensor. The two-dimensional sensor may be configured by arranging a plurality of one-dimensional CCD sensors or one-dimensional CMOS sensors each obtained by one-dimensionally arraying photoelectric conversion elements.

An optical system (second optical system) 109 causes reference light generated by the reference light generation unit 102 to reach the detection unit 108 so that light of a dominant wavelength becomes parallel light. In other words, the optical system 109 causes reference light to reach the detection unit 108 so that respective reference beams of reference light generated by the reference light generation unit 102 reach corresponding detection regions. Note that light of a dominant wavelength is light of an arbitrary wavelength among beams of a plurality of wavelengths emitted by the low-coherent light source 101 (for example, light of a wavelength having a highest energy intensity among beams of a plurality of wavelengths). The optical system 109 is formed from a mirror and half mirror in FIG. 1A, but may include a lens and another optical element.

An optical system (fifth optical system) 110 is inserted in an optical path between the reference light generation unit 102 (optical path length difference generation unit 201) and the detection unit 108 to reduce chromatic dispersion for the dominant wavelength out of chromatic dispersion generated when the reference light generation unit 102 generates reference light. The optical system 110 is formed from one lens in FIG. 1A, but may be formed from a plurality of lenses, a plurality of mirrors, or the like to reduce chromatic dispersion for the dominant wavelength. Note that chromatic dispersion contains a component having no rotational symmetry. Thus, the optical system 110 may include at least one rotation asymmetry optical element with an optical surface of a rotation asymmetry shape having no rotation symmetry axis.

An optical system (third optical system) 106 focuses, on the measurement point of the surface 103 to be measured, the other beam (second light) out of two beams split by the half mirror 104. The optical system 106 is formed from one lens in FIG. 1A, but may be formed from a plurality of lenses, a plurality of mirrors, or the like to focus light on the measurement point of the surface 103 to be measured. The optical system 106 may include a focus position change mechanism which changes the focus position, or an autofocus mechanism which automatically changes the focus position to an optimum position.

An optical system (fourth optical system) 107 causes light reflected at the measurement point of the surface 103 to be measured to reach the detection unit 108 as parallel light (almost parallel light). In other words, the optical system 109 causes light reflected at the measurement point of the surface 103 to be measured to reach the detection unit 108 as measurement light so that light reflected at the measurement point of the surface 103 to be measured reaches the respective detection regions of the detection unit 108. The optical system 107 is formed from one lens in FIG. 1A, but may be formed from a plurality of lenses, a plurality of mirrors, or the like. The optical systems 106 and 107 are formed from different optical systems in FIG. 1A, but may be formed from one optical system 112, as shown in FIG. 1B. The optical system 112 has the functions of the optical systems 106 and 107.

In the measurement apparatus 100, beams (measurement beams) to impinge on the respective detection regions of the detection unit 108 out of light reflected at the measurement point of the surface 103 to be measured reach (the detection regions of) the detection unit 108 at almost the same optical path length (that is, no optical path length difference) from the measurement point. To the contrary, respective reference beams contained in reference light reach corresponding regions of the detection unit 108, and their optical path lengths have a two-dimensional distribution in (the detection regions of) the detection unit 108. The optical system 110 has reduced chromatic dispersion for the dominant wavelength in the reference light. Thus, the optical path lengths of beams of wavelengths other than the dominant wavelength have almost the same two-dimensional distribution as that of the optical path length of the dominant wavelength in (the detection regions of) the detection unit 108. In the respective detection regions of the detection unit 108, the intensities of interference beams between reference beams having different optical path lengths and measurement beams having almost the same optical path length are detected.

The intensity of the interference beam detected by the detection unit 108 maximizes when the optical path length of the reference beam and that of the measurement beam coincide with each other, and damps and oscillates as the difference (optical path length difference) between the optical path length of the reference beam and that of the measurement beam increases. By obtaining the optical path length of the reference beam at which the intensity of the interference beam maximizes, the processing unit 111 can obtain the height (height information) of the surface 103 to be measured up to the measurement point. In practice, it is difficult to obtain the optical path length of the reference beam at which the damped oscillation maximizes. Hence, the processing unit 111 obtains the envelope of the damped oscillation from several measurement results, regards the vertex position of the envelope as the position of the maximum value, and converts it into the height of the surface 103 to be measured.

To obtain the envelope of the damped oscillation at high precision, it is generally necessary to change the optical path length of the reference beam at an interval of about ⅛ of the dominant wavelength λ and detect the intensity of interference light. In conventional techniques as disclosed in Japanese Patent Laid-Open Nos. 2006-64610 and 2007-333470 and non-patent literature 1, the optical path length differences of reference beams have a one-dimensional distribution. Let m be the number of detection regions (pixels) of the detection unit that receive the reference beams. Then, assuming that reference beams different by d in optical path length reach the respective detection regions, the range of the height detectable by the detection unit is given by

d×m (1)

In the conventional techniques, even the measurable range (measurement range) of the height of a surface to be measured is limited to the range represented by expression (1). For example, for d=λ/8, the height of a surface to be measured cannot be measured unless (the measurement point of) the surface to be measured exists within the range of m×λ/8 from the reference position of the measurement apparatus. If d is set to a large value in order to widen the measurement range, the height of a surface to be measured cannot be measured at high accuracy.

In contrast, in the measurement apparatus 100 according to the embodiment, the optical path length differences of reference beams have a two-dimensional distribution, as described above. The number of detection regions (pixels) of the detection unit 108 that receive the reference beams is m×n. Therefore, the range of the height detectable by the detection unit 108 is given by

d×m×n (2)

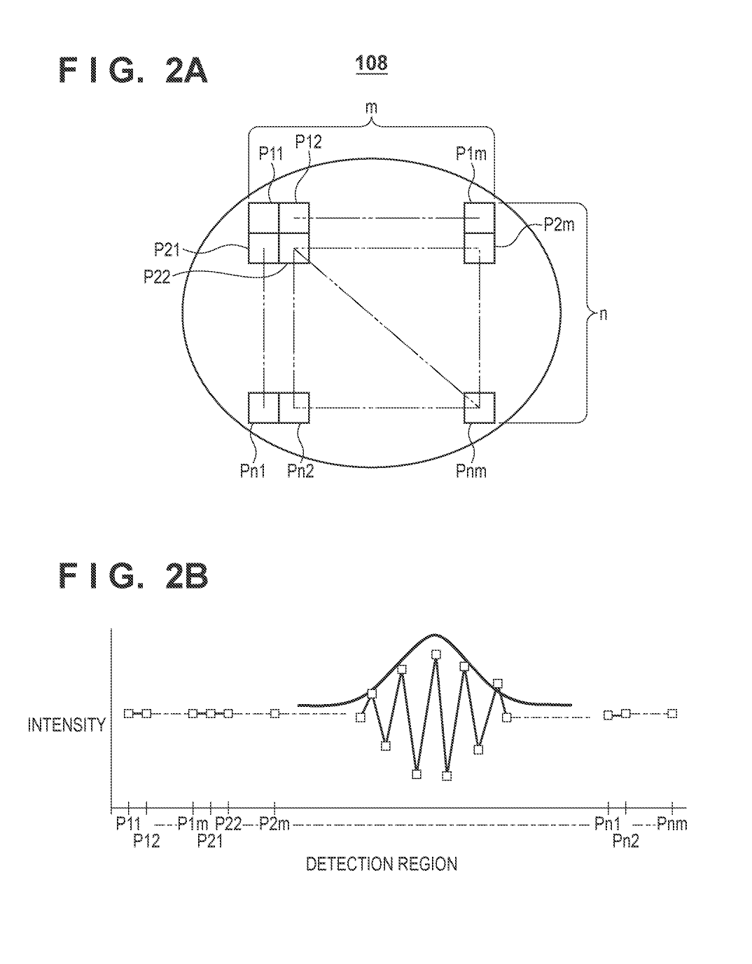

FIG. 2A exemplifies detection regions P11 to Pnm of the detection unit 108. Referring to FIG. 2A, the number of detection regions of the detection unit 108 that receive respective reference beams is m×n, and the optical path lengths of the reference beams incident on the respective detection regions P11 to Pnm are different by d. Compared to the conventional techniques, the measurement apparatus 100 can measure the height of the surface 103 to be measured at high accuracy while the measurable range (measurement range) of the height of the surface 103 to be measured is about n times larger.

FIG. 2B is a graph showing the relationship between the detection regions P11 to Pnm of the detection unit 108 and the intensities of interference beams detected in the detection regions P11 to Pnm. In this case, the optical path length of a reference beam incident on the detection region P11 is shortest. The optical path length of the incident reference beam increases by d in the order of the detection regions P12, P13, . . . , P1m, P21, P22, . . . , P2m, . . . , Pn1, Pn2, . . . , Pnm. In FIG. 2B, the intensities of interference beams detected by the detection unit 108 are plotted in ascending order of the optical path length of the reference beam. Thus, the abscissa in FIG. 2B can be converted into the optical path length of the reference beam. To obtain the height of (the measurement point of) the surface 103 to be measured from the intensity of interference light detected by the detection unit 108, an envelope indicated by a thick line in FIG. 2B is obtained by calculation or the like, as described above. The optical path length of a reference beam corresponding to the position of the maximum value of the envelope is obtained, thereby obtaining the height of the surface 103 to be measured. In other words, the processing unit 111 suffices to calculate a height at the measurement point from the intensity of interference light detected by the detection unit 108 based on the correspondence between the optical path lengths of reference beams incident on the respective detection regions of the detection unit 108, and these detection regions.

The conventional technique can obtain only the intensities of m interference beams because the intensities (information about the height of a surface to be measured) of interference beams are detected in only detection regions arrayed in one direction in the detection unit, for example, only the detection regions P11 to P1m. In FIG. 2B, no damped oscillation is obtained from the intensities of interference beams detected in the detection regions P11 to P1m, and no envelope can be obtained. In other words, the conventional technique cannot obtain the height of a surface to be measured. To the contrary, the measurement apparatus 100 in the embodiment detects the intensities of interference beams in the detection regions P11 to Pnm of the detection unit 108, and can obtain the intensities of m×n interference beams, implementing a wide measurement range.

In the conventional technique, when the surface to be measured exists outside the range represented by expression (1), it is necessary to change the optical path length of reference light by driving the reference surface for generating reference light or change the relative distance between the detection unit and the surface to be measured. Since the time to drive the reference surface is required, the height of the surface to be measured cannot be measured within a short time. In contrast, in the measurement apparatus 100 according to the embodiment, the measurable range of the height of the surface 103 to be measured is about n times larger than in the conventional technique, as described above. Therefore, the measurement apparatus 100 can measure the height of the surface 103 to be measured within a short time without requiring the above-described driving.

In the embodiment, reference beams different by d in optical path length impinge on the detection regions P11 to Pnm of the detection unit 108. However, the present invention is not limited to this. For example, the optical path lengths of some of reference beams incident on the detection regions P11 to Pnm of the detection unit 108 may overlap each other. In this case, the range of the height detectable by the detection unit 108 changes to a range obtained by excluding the overlap of the optical path length from the range represented by expression (2).

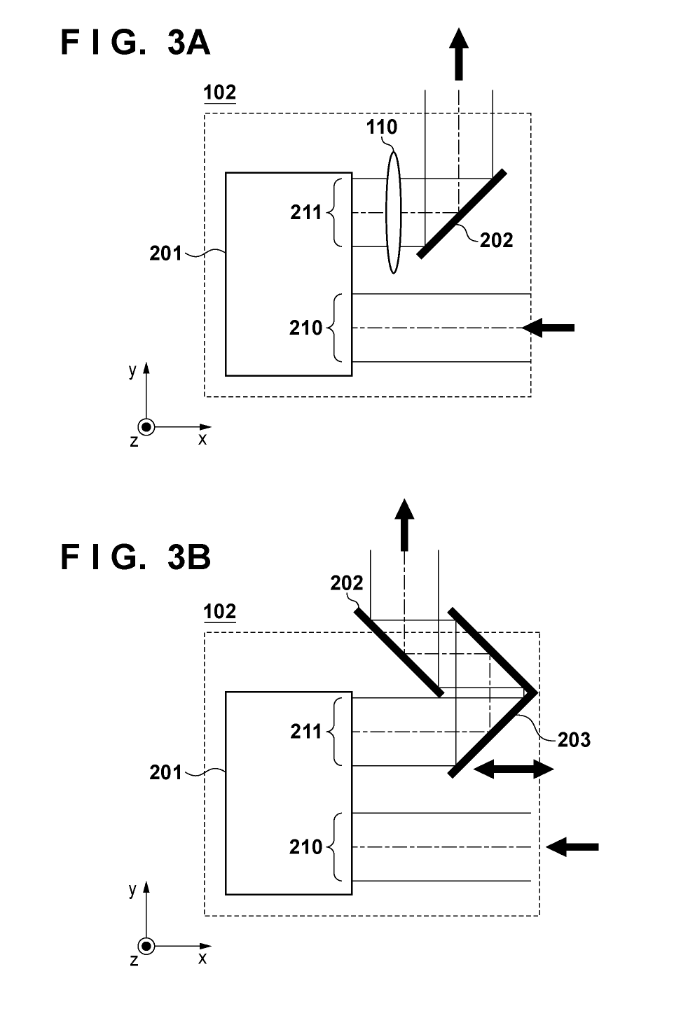

Next, the arrangement of the reference light generation unit 102 will be explained. As described above, the reference light generation unit 102 includes the optical path length difference generation unit 201 which generates two-dimensional optical path length differences in reference beams. FIGS. 3A and 3B are views schematically exemplifying the arrangement of the reference light generation unit 102.

Referring to FIG. 3A, a beam entering the reference light generation unit 102 out of two beams split by the half mirror 104 enters an entrance 210 of the optical path length difference generation unit 201 in the reference light generation unit 102, and emerges from an exit 211 of the optical path length difference generation unit 201. The light emerging from the exit 211 of the optical path length difference generation unit 201 emerges from the reference light generation unit 102 via an optical system 202. The optical system 202 is arranged to select the direction (exit direction) in which light emerges from the reference light generation unit 102. The optical system 202 is formed from one mirror in FIG. 3A, but may be formed from a plurality of lenses, a plurality of mirrors, or the like. In FIG. 1A, the optical system 110 is inserted in an optical path between the reference light generation unit 102 and the optical system 109. However, the optical system 110 suffices to be inserted in an optical path between the optical path length difference generation unit 201 and the detection unit 108. For example, the optical system 110 may be incorporated in the reference light generation unit 102, as shown in FIG. 3A.

To further widen the measurement range represented by expression (2), the arrangement of the reference light generation unit 102 is changed to an arrangement shown in FIG. 3B. The reference light generation unit 102 shown in FIG. 3B includes an optical system 203, and a driving unit (not shown) for driving the optical system 203, in addition to the arrangement shown in FIG. 3A. In the reference light generation unit 102 shown in FIG. 3B, the optical path length up to the detection unit 108 can be changed (for example, prolonged) by driving the optical system 203 by the driving unit, and the measurement range can be further widened. The optical system 203 is formed from two mirrors in FIG. 3B, but may include a lens and another optical element to change the optical path length up to the detection unit 108.

In the reference light generation unit 102 shown in FIG. 3B, d (optical path length difference) is set to a value equal to or larger than the wavelength, and the step (unit driving amount) of the driving amount of the optical system 203 by the driving unit is set to be equal to or smaller than the wavelength. These settings can further widen the measurement range.

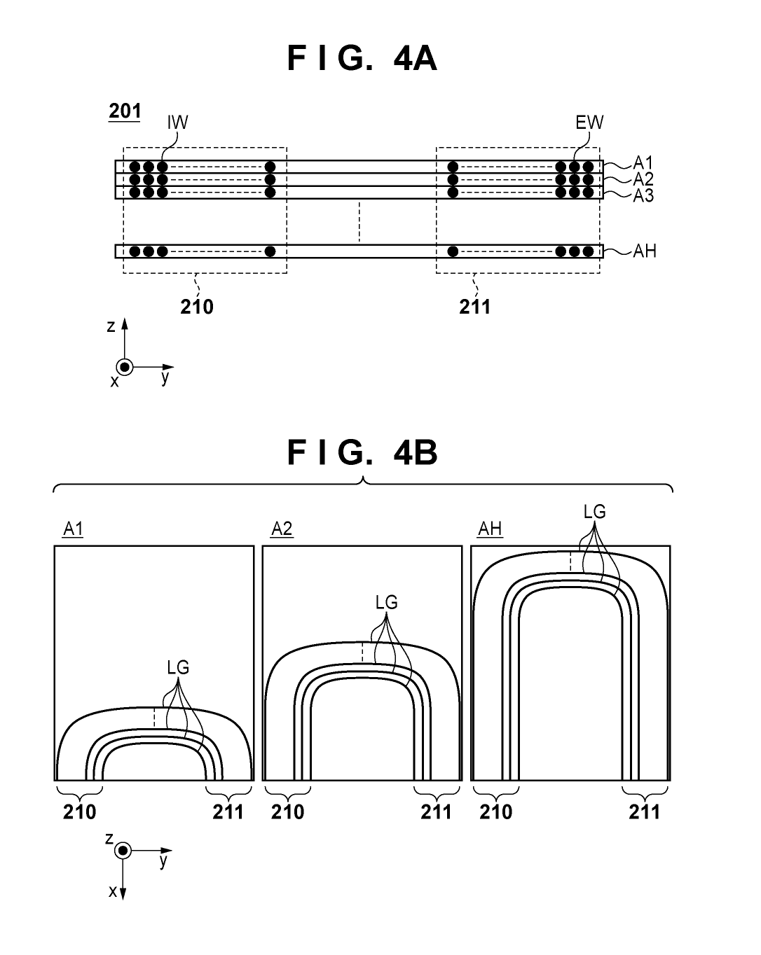

FIGS. 4A and 4B are views schematically exemplifying the arrangement of the optical path length difference generation unit 201. The optical path length difference generation unit 201 includes a plurality of optical waveguides LG different in distance (that is, length) between an entrance window IW which forms the entrance 210 and an exit window EW which forms the exit 211. The optical waveguides LG are formed from, for example, optical fibers, and two-dimensionally arrayed so that the respective exit windows EW are aligned in the first direction (for example, y-axis direction) and the second direction (for example, z-axis direction) perpendicular to the first direction. More specifically, as shown in FIG. 4A, the optical path length difference generation unit 201 is formed by stacking a plurality of layers A1 to AH each including the optical waveguides LG having the entrance windows IW and exit windows EW aligned in the y-axis direction are stacked in the z-axis direction. As shown in FIG. 4B, the distances each between the entrance window IW and exit window EW of each of the optical waveguides LG included in the layer A1 differ from each other by d. Similarly, the distances each between the entrance window IW and exit window EW of each of the optical waveguides LG included in each of the layers A2 to AH differ from each other by d. Preferably, the distances each between the entrance window IW and exit window EW of each of the optical waveguides LG included in the layers A1 to AH do not overlap each other, but may overlap each other in terms of manufacturing difficulty or the like.

Referring to FIGS. 4A and 4B, beams entering the entrance 210 of the optical path length difference generation unit 201 pass through the optical waveguides LG which are arrayed two-dimensionally and are different in length. The beams emerging from the exit 211 of the optical path length difference generation unit 201 have two-dimensional optical path length differences.

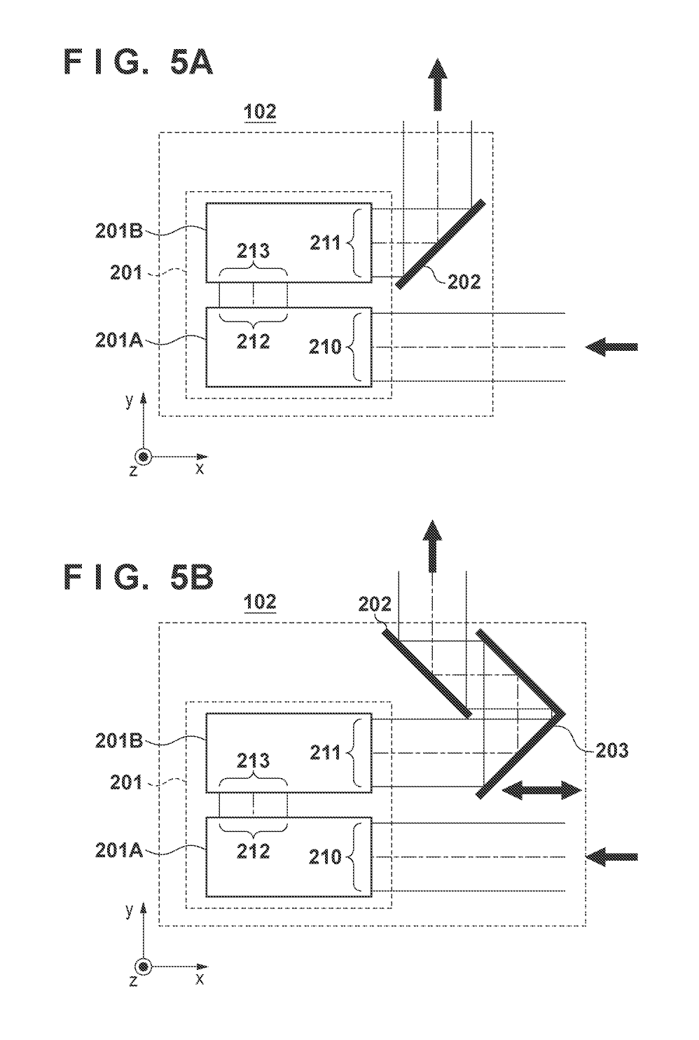

FIGS. 5A and 5B are views schematically exemplifying another arrangement of the reference light generation unit 102. As shown in FIGS. 5A and 5B, the reference light generation unit 102 includes a first optical path length difference generation unit 201A and second optical path length difference generation unit 201B as the optical path length difference generation unit 201. Each of the first optical path length difference generation unit 201A and second optical path length difference generation unit 201B includes at least one diffractive optical element, which will be described later.

Referring to FIG. 5A, a beam entering the reference light generation unit 102 out of two beams split by the half mirror 104 enters the entrance 210 of the first optical path length difference generation unit 201A, and emerges from an exit 212 of the first optical path length difference generation unit 201A. The beam emerging from the exit 212 of the first optical path length difference generation unit 201A enters an entrance 213 of the second optical path length difference generation unit 201B, and emerges from the exit 211 of the second optical path length difference generation unit 201B. The beam emerging from the exit 211 of the second optical path length difference generation unit 201B emerges from the reference light generation unit 102 via the optical system 202.

To further widen the measurement range represented by expression (2), the arrangement of the reference light generation unit 102 is changed to an arrangement shown in FIG. 5B. The reference light generation unit 102 shown in FIG. 5B includes the optical system 203, and the driving unit (not shown) for driving the optical system 203, in addition to the arrangement shown in FIG. 5A. As described above, in the reference light generation unit 102 shown in FIG. 5B, the optical path length up to the detection unit 108 can be changed (for example, prolonged) by driving the optical system 203 by the driving unit, and the measurement range can be further widened.

In the reference light generation unit 102 shown in FIG. 5B, d (optical path length difference) is set to a value equal to or larger than the wavelength, and the step (unit driving amount) of the driving amount of the optical system 203 by the driving unit is set to be equal to or smaller than the wavelength. These settings can further widen the measurement range.

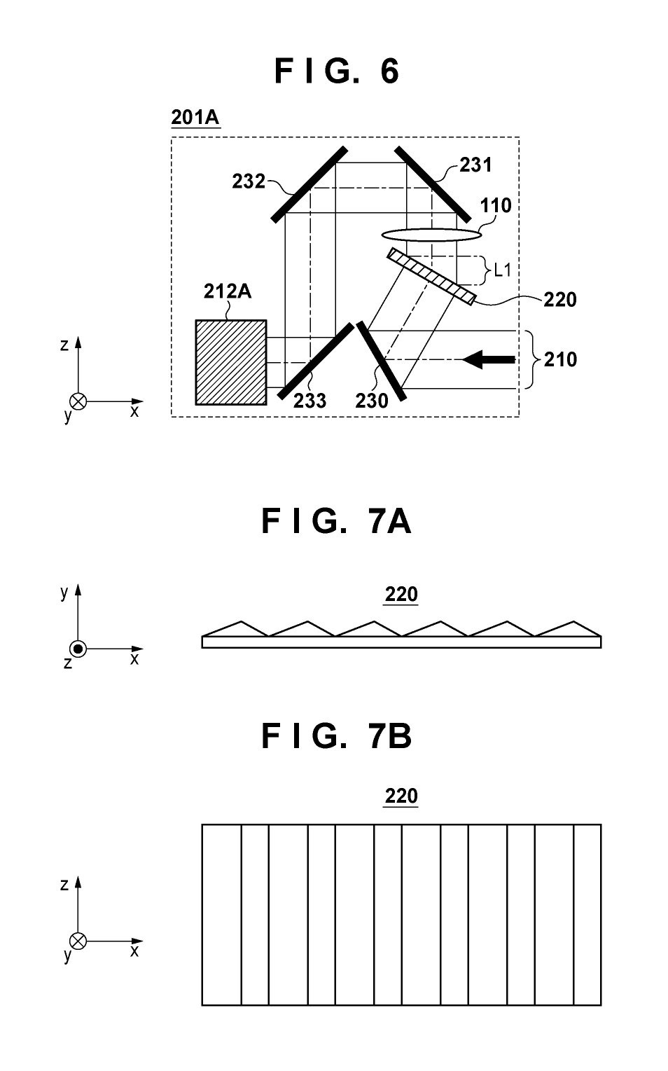

FIG. 6 is a view schematically showing the arrangement of the first optical path length difference generation unit 201A. Referring to FIG. 6, light entering the entrance 210 is deflected by a mirror 230, enters a first diffractive optical element 220, and is diffracted by the first diffractive optical element 220. The light diffracted by the first diffractive optical element 220 is deflected by mirrors 231, 232, and 233 via the optical system 110. The light deflected by the mirror 233 emerges from the exit 212 via a mirror 212A for deflecting light in the y-axis direction. Note that the first optical path length difference generation unit 201A includes one diffractive optical element (first diffractive optical element 220) in FIG. 6, but may include a plurality of diffractive optical elements. The mirrors 212A and 230 to 233 are not limited to the arrangement shown in FIG. 6 as long as light entering the entrance 210 passes through the first diffractive optical element 220 and is guided to the exit 212. In FIG. 1A, the optical system 110 is inserted in an optical path between the reference light generation unit 102 and the optical system 109. However, the optical system 110 suffices to be inserted in an optical path between the first optical path length difference generation unit 201A and the detection unit 108, and may be incorporated in, for example, the first optical path length difference generation unit 201A, as shown in FIG. 6. Note that chromatic dispersion is generated in the first diffractive optical element 220. Thus, the optical system 110 is arranged adjacent to the first diffractive optical element 220 in the direction in which light propagates, as shown in FIG. 6.

As shown in FIGS. 7A and 7B, the first diffractive optical element 220 has, on the x-y plane, a repetitive pattern for diffracting light (that is, generating diffracted light). FIGS. 7A and 7B are views schematically exemplifying the arrangement of the first diffractive optical element 220. FIG. 7A is a view showing projection of the first diffractive optical element 220 on the x-y plane. FIG. 7B is a view showing projection of the first diffractive optical element 220 on the x-z plane.

The first diffractive optical element 220 has a repetitive pattern formed in the x-axis direction (first direction). The direction in which the repetitive pattern is formed will be referred to as the repetition direction. In the first diffractive optical element 220, the repetitive pattern has a shape which selectively generates arbitrary diffracted light for the dominant wavelength.

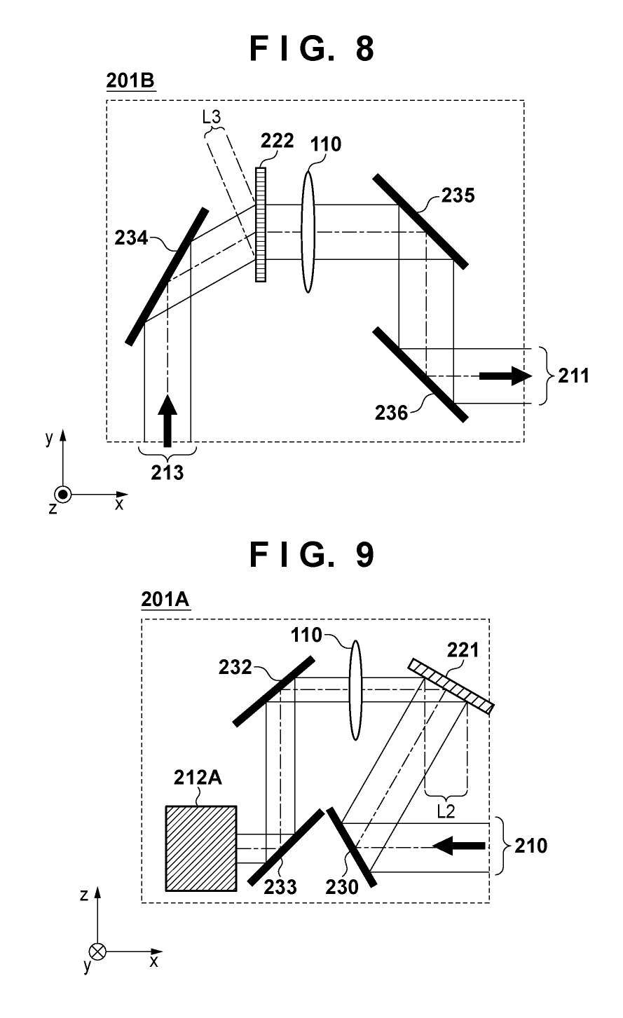

FIG. 8 is a view schematically showing the arrangement of the second optical path length difference generation unit 201B. Light emerging from the exit 212 of the first optical path length difference generation unit 201A enters the entrance 213 of the second optical path length difference generation unit 201B, and is deflected by a mirror 234. The light deflected by the mirror 234 is diffracted by a second diffractive optical element 222, deflected by mirrors 235 and 236 via the optical system 110, and emerges from the exit 211. Note that the second optical path length difference generation unit 201B includes one diffractive optical element (second diffractive optical element 222) in FIG. 8, but may include a plurality of diffractive optical elements. The mirrors 234 to 236 are not limited to the arrangement shown in FIG. 8 as long as light entering the entrance 213 passes through the second diffractive optical element 222 and is guided to the exit 211. In FIG. 1A, the optical system 110 is inserted in an optical path between the reference light generation unit 102 and the optical system 109. However, the optical system 110 suffices to be inserted in an optical path between the second optical path length difference generation unit 201B and the detection unit 108, and may be incorporated in, for example, the second optical path length difference generation unit 201B, as shown in FIG. 8. Note that chromatic dispersion is generated in the second diffractive optical element 222. Thus, the optical system 110 is arranged adjacent to the second diffractive optical element 222 in the direction in which light propagates, as shown in FIG. 8.

The second diffractive optical element 222 has, in the y-axis direction (second direction), a repetitive pattern for diffracting light (that is, generating diffracted light). In the second optical path length difference generation unit 201B, the second diffractive optical element 222 is arranged so that the repetition direction of the second diffractive optical element 222 becomes perpendicular to that of the first diffractive optical element 220. With this arrangement, the first optical path length difference generation unit 201A generates optical path length differences having a distribution in the repetition direction of the first diffractive optical element 220. The second optical path length difference generation unit 201B generates optical path length differences having a distribution in the repetition direction of the second diffractive optical element 222.

The first optical path length difference generation unit 201A will be geometrically explained with reference to FIG. 6. In the first optical path length difference generation unit 201A, the repetition direction of the first diffractive optical element 220 exists within the x-z plane. Incident beams pass through optical paths different by a maximum of a distance L1 within the x-z plane. Thus, the beams diffracted by the first diffractive optical element 220 have an optical path length difference of a maximum of the distance L1 in the repetition direction.

Similarly, the second optical path length difference generation unit 201B will be geometrically explained with reference to FIG. 8. In the second optical path length difference generation unit 201B, the repetition direction of the second diffractive optical element 222 exists along the y-axis. Incident beams pass through optical paths different by a maximum of a distance L3 within the x-y plane. The beams diffracted by the second diffractive optical element 222 have an optical path length difference of a maximum of the distance L3 in the repetition direction.

In this way, the first optical path length difference generation unit 201A and second optical path length difference generation unit 201B generate optical path lengths having distributions in two directions different from each other. In other words, the repetition direction of the first diffractive optical element 220 and that of the second diffractive optical element 222 are perpendicular to each other. With this arrangement, the first optical path length difference generation unit 201A and second optical path length difference generation unit 201B generate optical path lengths having distributions in two directions perpendicular to each other. Accordingly, the beams emerging from the exit 211 of the second optical path length difference generation unit 201B have two-dimensional optical path length differences.

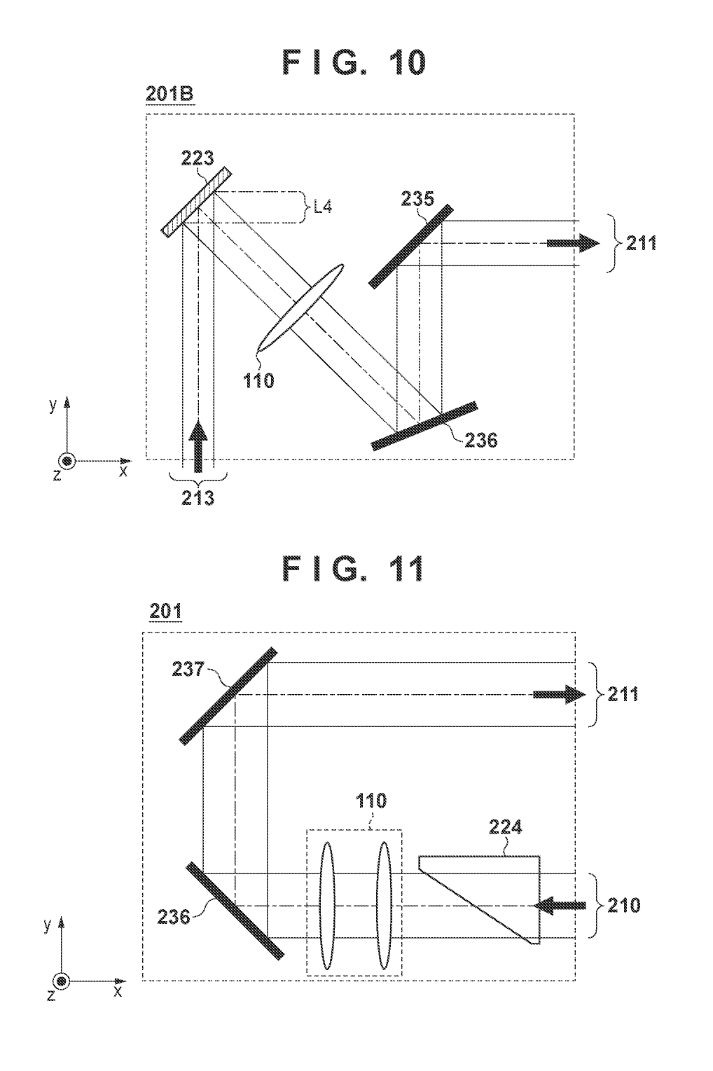

Note that the first optical path length difference generation unit 201A and second optical path length difference generation unit 201B include transmission diffractive optical elements in FIGS. 6 and 8, but are not limited to them. For example, as shown in FIGS. 9 and 10, the first optical path length difference generation unit 201A and second optical path length difference generation unit 201B may include reflection diffractive optical elements. FIG. 9 is a view schematically showing another arrangement of the first optical path length difference generation unit 201A. FIG. 10 is a view schematically showing another arrangement of the second optical path length difference generation unit 201B.

The first optical path length difference generation unit 201A shown in FIG. 9 includes a reflection first diffractive optical element 221 instead of the transmission first diffractive optical element 220. The second optical path length difference generation unit 201B shown in FIG. 10 includes a reflection second diffractive optical element 223 instead of the transmission second diffractive optical element 222. The repetition direction of the first diffractive optical element 221 exists within the x-z plane, and that of the second diffractive optical element 223 exists within the x-y plane.

The first optical path length difference generation unit 201A will be geometrically explained with reference to FIG. 9. In the first optical path length difference generation unit 201A, the repetition direction of the first diffractive optical element 221 exists within the x-z plane. Beams diffracted by the first diffractive optical element 221 have an optical path length difference of a maximum of a distance L2 in the repetition direction.

Similarly, the second optical path length difference generation unit 201B will be geometrically explained with reference to FIG. 10. In the second optical path length difference generation unit 201B, the repetition direction of the second diffractive optical element 223 exists within the x-y plane. Beams diffracted by the second diffractive optical element 223 have an optical path length difference of a maximum of a distance L4 in the repetition direction.

The repetition direction of the first diffractive optical element 221 and that of the second diffractive optical element 223 are perpendicular to each other. With this arrangement, the first optical path length difference generation unit 201A and second optical path length difference generation unit 201B generate optical path lengths having distributions in two directions perpendicular to each other. As a result, the beams emerging from the exit 211 of the second optical path length difference generation unit 201B have two-dimensional optical path length differences.

In this fashion, beams having two-dimensional optical path length differences can be generated by appropriately combining the first optical path length difference generation unit 201A shown in FIG. 6 or 9 and the second optical path length difference generation unit 201B shown in FIG. 8 or 10.

FIG. 11 is a view schematically exemplifying another arrangement of the optical path length difference generation unit 201. The optical path length difference generation unit 201 shown in FIG. 11 includes at least one diffractive optical element, which will be described later.

Referring to FIG. 11, light entering the entrance 210 is diffracted by a diffractive optical element 224, deflected by the mirror 236 and a mirror 237 via the optical system 110, and emerges from the exit 211. Note that the mirrors 236 and 237 are not limited to the arrangement shown in FIG. 11 as long as light entering the entrance 210 passes through the diffractive optical element 224 and is guided to the exit 211. In FIG. 1A, the optical system 110 is inserted in an optical path between the reference light generation unit 102 and the optical system 109. However, the optical system 110 suffices to be inserted in an optical path between the optical path length difference generation unit 201 and the detection unit 108. For example, the optical system 110 may be incorporated in the optical path length difference generation unit 201, as shown in FIG. 11. Note that chromatic dispersion is generated in the diffractive optical element 224. Thus, the optical system 110 is arranged adjacent to the diffractive optical element 224 in the direction in which light propagates, as shown in FIG. 11. As will be described later, chromatic dispersion is generated in two different directions in the diffractive optical element 224. The optical system 110 includes at least two optical elements, as shown in FIG. 11.

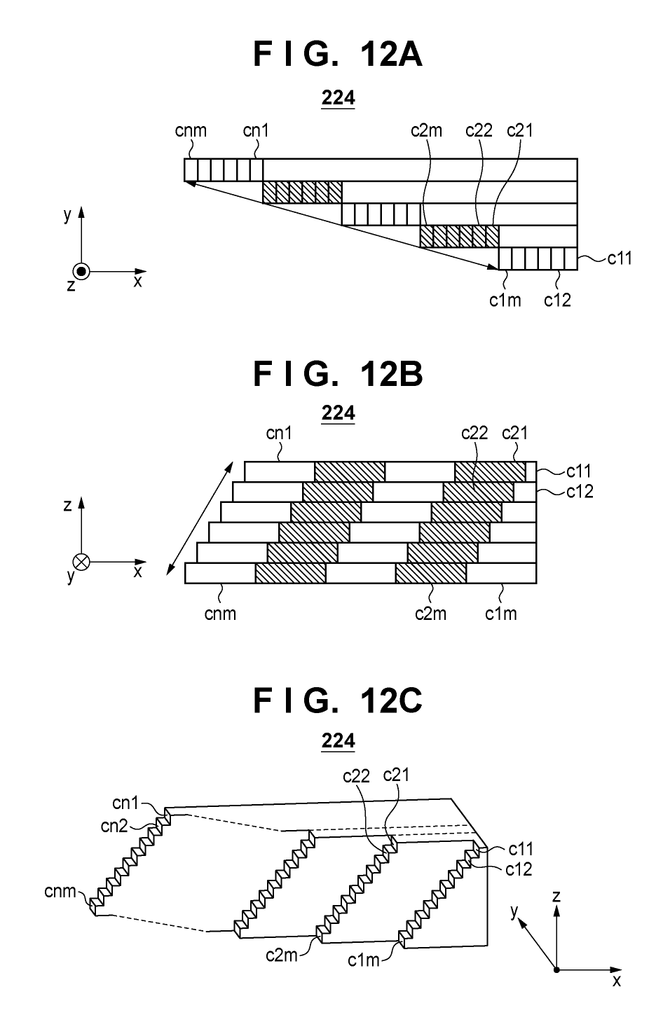

As shown in FIGS. 12A to 12C, the diffractive optical element 224 has, in two directions perpendicular to each other, repetitive patterns for diffracting light. FIGS. 12A to 12C are views schematically exemplifying the arrangement of the diffractive optical element 224. FIG. 12A is a view showing projection of the diffractive optical element 224 on the x-y plane. FIG. 12B is a view showing projection of the diffractive optical element 224 on the x-z plane. FIG. 12C is a perspective view showing the diffractive optical element 224.

Of the two repetition directions of the diffractive optical element 224, one repetition direction exists within the x-y plane, as indicated by an arrow in FIG. 12A. The other repetition direction exists within the x-z plane, as indicated by an arrow in FIG. 12B. Since the diffractive optical element 224 has two repetition directions perpendicular to each other, beams diffracted by the diffractive optical element 224 have two-dimensional optical path length differences. More specifically, beams entering the diffractive optical element 224 pass through step structures c11 to cnm. The step structures c11 to cnm have refractive indices different from that of air, and have different lengths in the direction in which light propagates. Hence, the beams having passed through the step structures c11 to cnm have different optical path lengths. In other words, two-dimensional optical path length differences are generated in the beams diffracted by the diffractive optical element 224 in accordance with the arrangement of the step structures c11 to cnm.

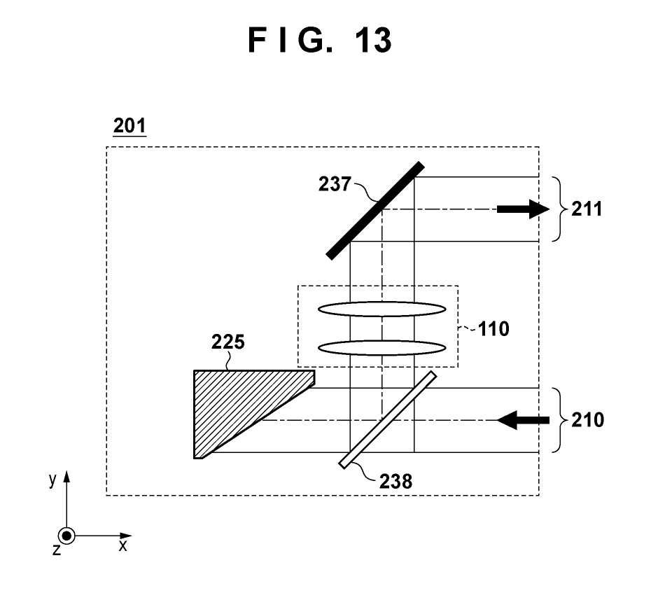

Note that the optical path length difference generation unit 201 includes a transmission diffractive optical element in FIG. 11, but is not limited to this. For example, as shown in FIG. 13, the optical path length difference generation unit 201 may include a reflection diffractive optical element. FIG. 13 is a view schematically showing another arrangement of the optical path length difference generation unit 201.

The optical path length difference generation unit 201 shown in FIG. 13 includes a reflection diffractive optical element 225 instead of the transmission diffractive optical element 224. Similar to the diffractive optical element 224, the diffractive optical element 225 has step structures obtained by reversing those shown in FIGS. 12A to 12C about the y-axis. Reflecting surfaces for reflecting light are formed on the surfaces of the step structures. Beams entering the diffractive optical element 225 are reflected by the reflecting surfaces of the step structures c11 to cnm. The reflecting surfaces of the step structures c11 to cnm exist at different positions in the direction in which light propagates. Thus, two-dimensional optical path length differences are generated in the beams reflected by the diffractive optical element 225 in accordance with the arrangement of the step structures c11 to cnm.

Note that the optical path length difference generation unit 201 includes one diffractive optical element (transmission diffractive optical element 224 or reflection diffractive optical element 225) in FIGS. 11 to 13, but may include a plurality of diffractive optical elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-103788 filed on May 6, 2011, which is hereby incorporated by reference herein in its entirety.

What is claimed is:

1. A measurement apparatus which measures a height of a surface to be measured, comprising:
a detection unit configured by two-dimensionally arraying a plurality of regions where an intensity of interference light between reference light and measurement light is detected;
a first optical system configured to split light emitted by a light source into first light and second light;
a generation unit configured to receive the first light, and generate, from the first light, the reference light including a plurality of reference beams having optical path length differences in two directions perpendicular to each other in cross section surface;
a second optical system configured to cause the reference light to reach the detection unit so as to cause the respective reference beams generated by the generation unit to reach the corresponding regions;
a third optical system configured to focus the second light on a measurement point of the surface to be measured;
a fourth optical system configured to cause the second light to reach the detection unit as the measurement light so as to cause the second light reflected by the measurement point to reach the respective regions; and
a processing unit configured to calculate the height of the surface to be measured at the measurement point from the intensity of the interference light detected in the respective regions.

2. The apparatus according to claim 1, wherein
the generation unit includes a plurality of optical waveguides having different distances between entrances which the first light enters and exits from which the first light emerges, and
the plurality of optical waveguides are arrayed to arrange the exits of the respective optical waveguides in a first direction and a second direction perpendicular to the first direction.

3. The apparatus according to claim 2, wherein the optical waveguide is formed from an optical fiber.

4. The apparatus according to claim 1, wherein
the generation unit includes a first diffractive optical element having, in a first direction, a repetitive pattern for diffracting light and a second diffractive optical element having, in a second direction, a repetitive pattern for diffracting light,
the first diffractive optical element and the second diffractive optical element are arranged to make the first direction and the second direction become perpendicular to each other, and
the first light diffracted by the repetitive pattern of the first diffractive optical element has an optical path length difference in the first direction, and the first light diffracted by the repetitive pattern of the second diffractive optical element has an optical path length difference in the second direction.

5. The apparatus according to claim 1, wherein
the generation unit includes a diffractive optical element having, in a first direction and a second direction perpendicular to the first direction, repetitive patterns for diffracting light, and
the first light diffracted by the repetitive pattern of the diffractive optical element has an optical path length difference in the first direction and the second direction.

6. The apparatus according to claim 1, further comprising a fifth optical system configured to be interposed between the generation unit and the detection unit and reduce chromatic dispersion generated when the generation unit generates the reference light.

7. The apparatus according to claim 6, wherein the fifth optical system includes a lens having a rotation asymmetry shape.

8. The apparatus according to claim 1, wherein the third optical system and the fourth optical system are formed from one optical system.

9. The apparatus according to claim 1, wherein the processing unit calculates the height of the surface to be measured based on a correspondence between optical path lengths of the respective reference beams incident on the respective regions, and the plurality of regions.
